(19) United States
(12) Patent Application Publication
(10) Pub. No.: US 2008/0035071 A1
(43) Pub. Date: Feb. 14, 2008

(54) Animal dental flossing article

(76) Inventor: Frank M. Veloce, Orono (CA)

Correspondence Address: MANELLI DENISON & SELTER, 2000 M STREET NW SUITE 700, WASHINGTON, DC, 20036-3307, US

(21) Appl. No.: 11/502,518

(22) Filed: Aug. 11, 2006

(51) Int. Cl. A01K 29/00

(52) U.S. Cl. 119/710

(57) ABSTRACT

An animal flossing bone having a bone length comprising a plurality of longitudinally-aligned fibers bound intermittently along the length to provide at least one fiber portion accessible to the teeth of an animal. The bone, optionally, contains a dental fluoride compound and a flavouring agent.

### FIELD OF THE INVENTION

This invention relates to an animal dental flossing article, particularly for cats and dogs.

### BACKGROUND OF THE INVENTION

Although animals, particularly dogs, still chew on hard objects which act as abrasives on their teeth and, thus, provide significant cleaning action, domesticated dogs and cats have been increasingly fed soft, non-abrasive canned foodstuffs with little or no abrasive action on the teeth.

### SUMMARY OF THE INVENTION

It is an object of the present invention to provide an article for use by an animal, particularly a cat or dog, that has dental abrasive properties.

Accordingly, the invention provides an animal flossing bone having a bone length comprising a plurality of longitudinally-aligned fibers bound intermittently along said length to provide at least one fiber portion accessible to the teeth of an animal.

In this specification, the term “bone” is used as, hereinabove defined, rather than the hard, naturally-produced animal bones.

The longitudinally-aligned fibers of use in the invention are, particularly, disposed parallel, one to the other, within the bundle. The bundle may be either straight or slightly spiral or gently twisted along the length of the bundle. The bundle may be of any suitable length, but preferably of a length selected from 5 cm to 25 cm.

The bundle may be of any suitable diameter convenient for the bundle to be picked-up and carried by the animal, and chewed. A bundle diameter of about 1 to 5 cm is preferred.

Each of the fibers may be of any suitable diameter effective for allowing abrasive action on the teeth when the bundle is chewed by the animal. The fibers may work on the outer surface of the teeth or, preferably, between the teeth in a flossing manner. A fiber diameter of about 0.2 to 1 mm is preferred.

Each of the fiber portions may be of any length convenient for the bundle of fibers to be accessible to the animal's teeth.

Preferably, the accessible fiber portion has a length selected from 2-8 cm. The bone length of fibers may be intermittently bound by any suitable material, such as, for example, wire, fiber, twine as a thread, tape or the like.

The fibers may be formed of one or more of a suitable and effective natural or synthetic material that does not undergo undue extensive deterioration, such as ready breakage of the fiber. The natural material may be selected, for example, from a cotton, twine, and hemp; while the synthetic material may be selected, for example, from an acrylic, polyester, polyamide or polyolefin, such as a polyethylene or polypropylene.

The bundle, preferably, contains at least a single strand of a crinkle material of suitable dimensions as to operably produce the crinkle sound when the bundle is manipulated by the animal, while not being readily destroyed or damaged by the teeth. The crinkle material, for example, may be metallic, such as an aluminum foil, or a plastics material.

Preferably, the bone as hereinabove defined further comprises a fluoride compound adhered to or embedded within said plurality of fibers.

The bone may also comprise a flavouring agent attractive to the animal adhered to or embedded within the plurality of fibers. Such a flavouring agent could be aniseed or a meat flavour for a dog, or a fish flavour for a cat.

### BRIEF DESCRIPTION OF THE DRAWINGS

In order that the invention may be better understood, a preferred embodiment will now be described, by way of example only, with reference to the accompanying drawing, wherein

FIG. 1 is a perspective view of an animal flossing bone, according to the invention.

### DETAILED DESCRIPTION OF PREFERRED EMBODIMENTS

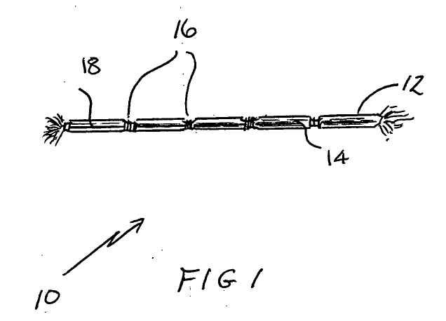

FIG. 1 shows generally as 10, a bundle 12 of longitudinally aligned individual fibers 14 formed of polypropylene of 0.2 mm diameter and 25 cm length.

Bundle 12 has an average diameter of about 4 cm and is bound by strips 16 intermittent at interstrip distances of 6 cm along the length of bundle 12. Beneath strips 16 is a longitudinal strip of crinkle aluminum 18.

Adhered to each of fibers 14 is a meat flavoured additive and, fluoride compound (not shown).

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. An animal flossing bone having a bone length comprising a plurality of longitudinally-aligned fibers bound intermittently along said length to provide at least one fiber portion accessible to the teeth of an animal.

2. A bone as defined in claim 1 comprising a plurality of said fiber portions.

3. A bone as defined in claim 1 wherein said fiber is a synthetic or natural material.

4. A bone as defined in claim 3 wherein said synthetic fiber is selected from the group consisting of an acrylic, polyester, polyamide and polyolefin material.

5. A bone as defined in claim 4 wherein said polyolefin is selected from polyethylene and polypropylene.

6. A bone as defined in claim 3 wherein said natural material is selected from cotton, twine, and hemp.

7. A bone as defined in claim 1 wherein said plurality of fibers further comprises at least one strand of a crinkle material of suitable dimensions as to operably effect a crinkle sound.

8. A bone as defined in claim 7 wherein said crinkle material is selected from a metallic material and a plastics material.

9. A bone as defined in claim 1 further comprising a fluoride compound adhered to or embedded within said plurality of fibers.

10. A bone as defined in claim 1 further comprising a flavouring agent adhered to or embedded within said plurality of fibers.

11. A bone as defined in claim 1 wherein each of said fibers has a diameter selected from 0.2 to 1 mm.

12. A bone as defined in claim 1 wherein said bone length is selected from 5 to 25 cm.

13. A bone as defined in claim 1 wherein said bound plurality of fibers has a diameter selected from 1 to 5 cm.

14. A bone as defined in claim 1 wherein said fiber portion has a length selected from 2-8 cm.

15. A bone as defined in claim 2 wherein said plurality of fibers further comprises at least one strand of a crinkle material of suitable dimensions as to operably effect a crinkle sound.

16. A bone as defined in claim 3 wherein said plurality of fibers further comprises at least one strand of a crinkle material of suitable dimensions as to operably effect a crinkle sound.

17. A bone as defined in claim 4 wherein said plurality of fibers further comprises at least one strand of a crinkle material of suitable dimensions as to operably effect a crinkle sound.

18. A bone as defined in claim 5 wherein said plurality of fibers further comprises at least one strand of a crinkle material of suitable dimensions as to operably effect a crinkle sound.

19. A bone as defined in claim 6 wherein said plurality of fibers further comprises at least one strand of a crinkle material of suitable dimensions as to operably effect a crinkle sound.

20. A bone as defined in claim 15 wherein said crinkle material is selected from a metallic material and a plastics material.
